(19) United States
(12) Patent Application Publication
(10) Pub. No.: US 2017/0136656 A1
(43) Pub. Date: May 18, 2017

(54) Early Signaling of an Imminent Interruption of the Water Supply By a Water Supply System

(71) Applicant: Hilti Aktiengesellschaft, Schaan (LI)

(72) Inventors: Helmut SPECHT, Bad Woerishofen (DE); Hans RUPPRECHT, Muenchen (DE); Eduard SEVER, Ludesch (AT)

(73) Assignee: Hilti Aktiengesellschaft, Schaan (LI)

(21) Appl. No.: 15/321,961

(22) PCT Filed: Jun. 24, 2015
(86) PCT No.: PCT/EP2015/064214

§ 371 Date: Dec. 23, 2016

(30) Foreign Application Priority Data
Jun. 25, 2014 (EP) 14173837.7

(51) Int. Cl. B28D 7/02; G08B 21/18; B28D 1/04

(52) U.S. Cl. CPC B28D 7/02; B28D 1/041; G08B 21/182

(57) ABSTRACT

A method for controlling a water supply system to be used with a machine tool, in particular a core boring device, is disclosed. The water supply system includes a water reservoir for storing water, a line for transporting water from the water reservoir to the machine tool, where the line contains a first section and a second section, a pump device for pumping water from the water reservoir to the machine tool, a signaling device, at least one sensor for measuring at least one parameter of the pump device, and a controller. The method includes transmitting a signal if at least one parameter of the pump device falls below a specified threshold for a specified duration and at least one specified water quantity for supplying the machine tool is available.

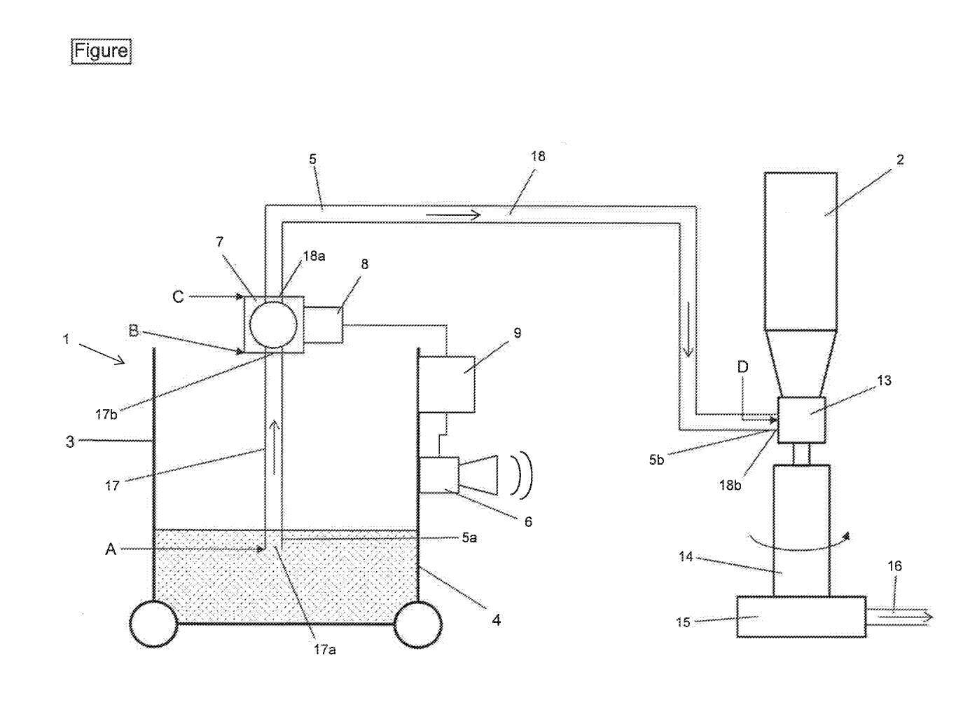

This application claims the priority of International Application No. PCT/EP2015/064214, filed Jun. 24, 2015, and European Patent Document No. 14173837.7, filed Jun. 25, 2014, the disclosures of which are expressly incorporated by reference herein.

### BACKGROUND AND SUMMARY OF THE INVENTION

The present invention relates to a method for controlling a water supply system to he used with a machine tool, particularly a core boring apparatus, comprising a water reservoir for storing water, a line for transporting water from the water reservoir to the machine tool, wherein the line contains a first section and a second section, a pump apparatus for delivering water from the water reservoir to the machine tool, a signaling device, at least one sensor for measuring at least one parameter of the pump device, and a control device.

A water supply system is a critical and essential necessity for almost every core boring apparatus as well as for numerous other tasks using large machine tools (e.g., saws or angle grinders). Particularly when using a core boring apparatus for drilling holes in mineral rock by means of a rotating drill bit, cooling and flushing of the individual components of the core boring apparatus and drill bit are required. Generally, there exists the possibility of connecting the core boring apparatus to a fresh. water line, e.g., a conventional water line, and thereby producing the necessary cooling and flushing. However, instead of connecting a core boring apparatus to a fresh water line, which cools the drill bit. when processing the material and correspondingly washes away the rock loosened by the drill bit as well as the dust, a water supply system offers the possibility of transporting a certain water supply to the construction site. To this end, the water supply system has a fresh water reservoir, in which a particular quantity of water is stored for cooling and flushing purposes. In addition, a water supply system has a line in. the form of a flexible hose to he able to pump the water to the machine tool or to the drill bit.

A water supply system to he used with a machine tool, such as a core boring apparatus, according to prior art is disclosed for example in German patent application DE 10 2006 035 345 A1.

Core boring work is complex and requires continuous monitoring of the core boring apparatus as well as the drill bit during preparation as well as throughout the entire execution of the actual drilling process. Among other things, the gear of the core boring apparatus, the drilling speed, the torque, the penetration rate as well as the water quantity needed for cooling and flushing must he changed and adjusted respectively. In addition, one must ensure a continual and sufficient flow of water to the core boring apparatus and the drill hit during the entire core boring process. The water thereby serves both to cool the core boring apparatus as well as to flush out drilling sludge (mixture of loosened stone, dust and water) from the drill bit. If a sufficient water flow can no longer be delivered to the core boring apparatus and to the drill bit, there is the risk that the core boring apparatus can overheat and the drill bit can get jammed in the drilled hole. As a result, the core boring apparatus and the drill bit may become permanently damaged, which may result in the delayed completion of the core boring as well as high costs for the time-intensive disassembly of the stuck drill bit and its repair.

The object of the present invention is to solve the problems described above and to provide in particular a method for controlling a water supply system for use with a machine tool, particularly a core boring apparatus, with which the damage to the machine tool and the drill bit due to an insufficient water supply can be effectively avoided.

To this end, a method is provided for controlling a water supply system for use with a machine tool, particularly a core boring apparatus, containing a water reservoir for storing water, a line for transporting water from the water reservoir to the machine tool, wherein the line has a first section and a second section, a pump device for delivering water from the water reservoir to the machine tool, a signaling device, at least one sensor for measuring at least one parameter of the pump device, and a control device.

The method is characterized according to the invention by the following steps.

Transmitting a signal if at least one parameter of the pump device falls below a predetermined threshold for a predetermined period and at least one predetermined water quantity is available for supplying the machine tool.

By transmitting a signal, the user of the core boring apparatus is informed in a timely manner while carrying out a core boring task that only a small amount of water for cooling and flushing is available and corresponding measures, such as interrupting the core boring operation for example, must be initiated to prevent the drill bit from getting jammed or other damage.

According to an advantageous embodiment of the present invention, it may be possible that the at least one parameter of the pump device is the water pressure in the pump device.

According to another advantageous embodiment, it is possible that the at least one parameter of the pump device is the input power of the pump device.

To provide a minimum quantity of water to supply the machine tool after transmitting the signal, it is conceivable that the predetermined water quantity is realized by the interior volume of the second section of the line.

Additional advantages emerge from the following drawing descriptions. The drawing depicts various embodiments of the present invention. The drawing, the description, and the claims contain numerous features in combination. Where appropriate, a person skilled in the art will also consider the features individually and put them together into other reasonable combinations.

### BRIEF DESCRIPTION OF THE DRAWING

The FIGURE shows a schematic illustration of a water supply system and a machine tool designed as a core boring apparatus,

### DETAILED DESCRIPTION OF THE DRAWING

The Figure depicts a water supply system 1, which is connected to a machine tool 2. Water supply system 1 is designed to execute the method according to the invention.

Water supply system 1. essentially comprises a housing 3, a water reservoir 4 for storing water, a line 5 to transport water from water reservoir 4 to machine tool 2 designed as a core boring apparatus, a signaling device 6, a pump device 7 for delivering water from water reservoir 4 to core boring apparatus 2, a sensor 8 for measuring at least one parameter of pump device 7 and a control device 9.

Housing 3 is designed essentially as a hollow body.

Water reservoir 4 is positioned in housing 3 and serves as a supply vessel for water. Alternatively, a different suitable liquid may also be used.

Line 5 is designed in the form of a flexible hose and comprises a first end 5a and a second end 5b. As described below in detail, line 5 comprises a first section 17 and a second section 18. First end 5a of line 5 projects into water reservoir 4 and the supply of water, Second end. 5b of line 5 is connected to a connection piece 13 on core boring apparatus 2. Line 5 serves to transport fresh water from water reservoir 4 to a tool 14 designed as a drill bit. As depicted in the Figure, line 5 is connected to core boring apparatus 2 via connection piece 13 in such a manner that the water reaches the interior of drill bit 14. The water cools and flushes drill bit 14 during a drilling process. To do so, the water penetrates through a first end of drill bit 14 into the interior of drill bit 14 and emerges through a second end out of drill bit 14. Drill bit 14 comprises at the second end a collection apparatus 15 with an outlet port 16. Through outlet port 16, the water along with the (not depicted) drilling sludge emerges from drill bit 14 for disposal purposes. According to an alternative design, it may also be provided that line 5 is first guided through core boring apparatus 2 for cooling purposes before it ultimately reaches drill bit 14 for cooling and flushing.

According to an. advantageous embodiment, the diameter of line 5 is six millimeters (6 mm). It is also possible that the diameter is less than 6 mm. A maximum diameter of 6 mm for line 5 ensures that at least the water, which is located in the line downstream from pump device 7, is still delivered to drill bit 14 if a section of line 5 upstream from pump device 7 contains no more water and pump device 7 only pumps air instead of water.

Pump device 7 is connected to line 5 and serves to deliver or pump fresh water from water reservoir 4 to drill bit 14. Pump device 7 is a membrane pump. However, it is also possible to use any other type of suitable pump. Due to the positioning of pump device 7 in line 5, line 5 is divided into a first section 17 (segment A to B) and into a second section 18 (segment C to D). First section 17 comprises a first end 17a and a second end 17b. First end 17a of first section 17 projects into the water supply of water reservoir 4, Second end 17b of first section 17 is connected to pump device 7. Second section 18 of line 5 comprises a first end 18a and a second end 18b. First end 18a of second section 18 is connected to pump device 7. Second end 18b of second section 18 is connected to connection piece 13.

Sensor 8 for measuring at least one parameter of pump device 7 is designed as a water pressure sensor according to the embodiment depicted in the Figure. According to an alternative but not depicted embodiment, sensor 8 may also be designed as a sensor for measuring the input power of pump device 7.

Water pressure sensor 8 depicted in the Figure is connected to pump device 7 and serves to measure the water pressure in pump device 7. According to an alternative and non-depicted embodiment, it is also possible that water pressure sensor 8 does not measure the water pressure in pump device 7, but in the first and/or second section 17, 18 of line 5.

Signaling device 6 is designed, according to the embodiment depicted in the Figure, as an acoustic signal transmitter (horn). According to an alternative and non-depicted embodiment, signaling device 6 may also be designed as a visual signal transmitter (light) or also as a combination of an acoustic and a visual signal transmitter.

Control device 9 is connected to sensor 8 and signaling device 6. Control device 9 serves to receive and analyze data, particularly measurement data from sensor 8. Furthermore, control device 9 monitors, controls, and regulates pump device 7. In addition, control device 9 controls signaling device 6. Stored in control device 9 are thresholds or limits for the individual parameters, particularly water pressure in pump device 7 and input power of pump device 7.

To operate the water supply system 1 in connection with core boring apparatus 2, core boring apparatus 2 is connected to line 5 for supplying water for cooling and flushing (see the Figure). Pump device 7 delivers water from water reservoir 4 via line 5 to drill bit 14. Sensor 8 designed as a water pressure sensor continually measures the water pressure in pump device 7 and sends this data to control device 9. Control device 9 continually compares the received measurement data against the thresholds stored in control device 9. When the water pressure in pump device 7 falls below a certain threshold for a certain period of time due to an empty water reservoir 4 as well as an empty first section 17 of line 5, control device 9 sends a corresponding signal to the signaling device (horn). Signaling device 6 designed as a horn emits a warning signal to inform the, user (not depicted) of core boring apparatus 2 that the water supply is almost depleted. Upon issuing the warning signal, only the interior volume of second section 18 of line 5 is available for cooling and flushing drill bit 14. Pump device 7 designed as a membrane pump is able to continue pumping the water remaining in second section 18 of line 5 to drill bit 14. When the warning signal is given, the user of core boring apparatus 2 knows that only the content (interior volume) of second section 18 of line 5 will be pumped to drill bit 14 and in a short time, no water at all will be pumped. After the warning signal is given, the user consequently has only time to properly end the core boring process, i.e., to reduce the rotational speed of drill bit 14 in such a manner that drill bit 14 comes to a standstill with the last of the delivered water. One can hereby effectively prevent that drill bit 14 is operated in a “dry” (i.e., without water) state during the core boring process.

According to another advantageous embodiment, sensor 8 is designed in such a manner that the input power of pump device 7 is measured. The data measured by sensor 8 is sent to control device 9 and compared with correspondingly stored thresholds. If due to an empty water reservoir 4 and an empty first section 17 of line 5 the sent measurement data fall below the thresholds for a certain period of time, a warning signal is issued via signaling device 6. As already described above, the warning signal serves to inform the user that the water supply is almost used up and only the content (interior volume) of second section 18 of line 5 is available for cooling and flushing.

1.-4. (canceled)

5. A method for controlling a water supply system for use with a machine tool, wherein the water supply system comprises:
a water reservoir, wherein the water reservoir stores water;
a line, wherein the water is transportable from the water reservoir to the machine tool via the line and wherein the line includes a first section and a second section;
a pump device, wherein the water is deliverable from the water reservoir to the machine tool via the line by the pump device;
a sensor, wherein at least one parameter of the pump device is measurable by the sensor;
a control device coupled to the sensor; and
a signaling device coupled to the control device;
and comprising the step of:
transmitting a signal by the control device to the signaling device when the at least one parameter of the pump device measured by the sensor falls below a predetermined threshold for a predetermined duration and at least one predetermined water quantity is available for supplying the machine tool.

6. The method according to claim 5, wherein the at least one parameter of the pump device is a water pressure in the pump device.

7. The method according to claim 5, wherein the at least one parameter of the pump device is an input power of the pump device.

8. The method according to claim 5, wherein the at least one predetermined water quantity is available in an interior volume of the second section of the line.

9. The method according to claim 5, wherein the machine tool is a core boring apparatus.
